(19) United States
(12) Patent Application Publication
(10) Pub. No.: US 2024/0304398 A1
(43) Pub. Date: Sep. 12, 2024

(54) MOLECULAR HYPER CAPACITOR

(71) Applicants: UNIVERSIDADE ESTADUAL PAULISTA JULIO DE MESQUITA FILHO, Säo Paulo (BR); NANUM NANOTECNOLOGIA S.A., Lagoa Santa (BR)

(72) Inventors: Paulo Roberto BUENO, Araraquara (BR); José Fernando CONTADINI, Lagoa Santa (BR)

(73) Assignees: UNIVERSIDADE ESTADUAL PAULISTA JULIO DE MESQUITA FILHO, São Paulo (BR); NANUM NANOTECNOLOGIA S.A, Lagoa Santa (BR)

(21) Appl. No.: 18/274,703

(22) PCT Filed: Jan. 25, 2022
(86) PCT No.: PCT/BR2022/050019

§ 371 Date: Jul. 27, 2023

(30) Foreign Application Priority Data
Feb. 3, 2021 (BR) 1020210020130

(51) Int. Cl. H01G 11/26; H01G 11/02; H01G 11/04; H01G 11/46; H01G 11/48; H01G 11/60; H01G 11/62

(52) U.S. Cl. CPC H01G 11/26; H01G 11/02; H01G 11/04; H01G 11/46; H01G 11/48; H01G 11/60; H01G 11/62

(57) ABSTRACT

Disclosed herein is an energy storage device, characterized as a molecular capacitor, and called hyper capacitor due its high energy density. It contains at least one modified electrode, formed by a composite material that mix at the mesoscopic nanoscale an electric conductive material with a molecular thin film, auto assembled or chemically or physically coupled, composed of active redox molecules in which the shielding of the electric field is of a mechanical quantum nature. The device has volumetric energy density above 35 Wh L⁻¹ and gravity energy density above 140 Wh kg⁻¹.

### FIELD OF THE INVENTION

The present disclosure deal with a device called Molecular Hyper capacitor that relates generally to the fields of energy storage devices and particularly to the super or hyper-capacitive phenomena such as the fields of electrochemical capacitors, ultra-capacitors and super-capacitors. It addresses the energy storage occurring at the molecular scale (or nanoscale) in an electrochemistry setting in which the control and design of it at the molecular scale leads to the control of a hyper-capacitive phenomena much stronger than the well taught super-capacitive one. This demonstration of a more efficient contribution based on pseudo-capacitive phenomena controlled at the nanoscale for an efficient electrical energy storage is new and key to the development of hyper-capacitive devices.

### BACKGROUND OF THE INVENTION

Energy storage in capacitive devices is old knowledge and has been improved overtime as science learns more and more about quantum phenomena at atomic and molecular scales. The finding of non-Faradaic electrochemical capacitance, as the case of electrical double layer capacitances, where features of the surface's geometry (such as the surface area) are dominant, generating capacitors devices with values around 1 to 100 μF/g of the electrode material. Later on, super-capacitors were developed based on the pseudo-capacitance knowledge, that are capacitances based mainly on Faradaic effects and reactions of oxi-reduction, that contributes additionally, generating high energy density electrode configurations and devices having capacitance values around 50 to 130 F/g. This invention teach that is possible now to go one step further and to explore phenomena of pseudo-capacitance at the atomic or molecular scale, called atomic or quantum capacitance, whose electrode materials are designed on a molecular scale. By doing that it is taught how to generate new devices called Molecular Hyper-Capacitors with values around 500 to 2,000 F/g and offering several configuration alternatives to adequate the cost-benefit for each different desired application.

We briefly discuss below molecular phenomena that impact the origins of the hyper-capacitance and demonstrate how to control it to develop hyper-capacitors, exteriorizing that, at the molecular scale or at the nanoscale down to 5 nm, the charge accumulation is not dissociated from a dynamic electron transport. Therefore, electrochemical reactions governed by electron transfer reaction, especially those of the resonant type, can be linked to the hyper-capacitive phenomena, depending on the control of the electronic structure of nano-capacitive building blocks (that form the electrically active material) coupled to an electrochemical interface, particularly in an architecture electrode/active material/electrolyte. In this case, the energy is not only associated with the spatial separation of charge in between the electrode and the molecular entities (electroactives) of the interface, but additionally it involves the energy associated to the electronic structure (atomic) of the molecular entities that form the active material of electrode; the quantized energy levels (associated with the boundary orbitals) of the electrically active molecular portions of the interface (electrochemical nano junctions) are essential when properly integrated with the macroscopic electrode. In this case, the integration of the molecules with the electrode is the key to the existence of this additional contribution that comprises quantum capacitive phenomena or simply, also called chemical capacitors. The development of hyper capacitor devices is, therefore, based on a mesoscopic method, dealing with nanoscale properties (in which there are conventional electrostatic contributions plus those associated with the electronic structure). The mesoscopic methods therefore involve loading a molecular set of junctions in an electrochemical environment where both electrostatic and chemical capacitances have a contribution, but in which chemistry is preponderant and promotes the phenomenon of hyper capacitance.

The term mesoscopic, as stated above, refers to a chemical system in which the total energy is divided between two mechanical states; it deals with mechanical systems whose dimensional scale allows quantum properties to predominate and significantly influence the system properties and, therefore, mesoscopic scales can be used in a providential way to improve the properties of materials and chemical compounds. Therefore, modelling a phenomenon on a mesoscopic scale it must incorporate the procedures of both mechanics, quantum and classical, in such a way one can understand and control the properties of the system as a whole. Consequently, a mesoscopic chemical state is often the state of a nanometric or molecular system (for example, a molecular film attached or anchored to an electrode) and, as such, deals with the basic questions of how rules in quantum mechanics operate concomitantly with the regime of classical mechanics. Essentially, within this context, it is possible to create electroactives interfaces having mesoscopic characteristic in which, depending on the charged state of the interface and of how the associated electrochemical reactions are coupled to the electrode states, there is a specific shielding of the electric field. This specific shielding of the electric field differs from that generally attributed to the double electric layer, which is generally attributed to phenomena of the Debye-Hückel type of electrical shielding (domain of classical mechanics), being in particular the type Thomas-Fermi (domain of quantum mechanics). As the system is mesoscopic, both shields of the electric field can operate concurrently, but the phenomenon of hyper capacitance depends on how to maximize the Thomas-Fermi shield.

Ultimately, when solving a Hamiltonian of the functional's electronic density, of an electrochemical interface where there is no diffusive contribution (which applies to cases in which the working scale is less than 5 nm) by considering a disturbance of the electronic structure of a mesoscopic system, allow that this approach based on the first principles of quantum mechanics solve the energy of the system and, consequently, its properties. In principle, therefore, it is possible, through the capacitive state of electrochemical systems on a molecular scale connected to a macroscopic conductive electrode, to resolve the properties of the interface. When these capacitive states are resolved, essentially, two different energetic contributions appear (as a consequence of this Hamiltonian's analytical solution). Thus, the solution of the quantum mechanics of the system can be summarized, in terms of capacitive quantities (which help us to associate directly with experimental observables), such as:

$$\frac{1}{{C}_{μ}} = ( \frac{1}{{C}_{e}} + \frac{1}{{C}_{q}} ) , \qquad ( 1 )$$

In equation (1) Cₑ is the electrostatic capacitance of the electrochemical interface and the term C_{q} is the quantum capacitive term that relates to the contributions achieved during the loading of the electronic states accessible at the interface, from a disturbance made on the electrode to the molecular states attached to it. Essentially, 1/C_{q} is equivalent to the differences between the conduction band and valence, or to the states HOMO (the highest occupied molecular orbital) and LUMO (the lowest unoccupied molecular orbital) of the individual molecular components coupled to the electrode.

These accessible electronic states are those that can be related to faradaic charge processes, where electrons are transferred from the (metallic) conductors of the electrode to the molecules and vice versa, in a dynamic and resonant electron transfer regime, being the electric field screened by the ions in the electrolyte—that involve the pseudocapacitive effects. These are electronically accessible states that often contribute to the capacitive charge at the interface formed by these compounds and that chemically modify the surface or the electrode's conductive interface (metallic); this structure is called by electrochemists as modified electrodes. Thus, in the absence of diffusion, the quantum capacitive term can be quantified as 1/C_{q}∝δμ/δ [symbol] , i.e. it is proportional to the variation in the chemical potential μ for a given number of electronic particles [symbol] exchanged—note that C_{q}∝δ [symbol] /δμ where δ [symbol] /δμ is the electronic density-of-states (DOS). This last phenomenon of charge storage is a pseudocapacitive contribution that gives rise, if properly engineered, to the hyper capacitance phenomena associated to the electron transfer dynamics, as is generally the case observed experimentally in rechargeable battery devices, and recognised as being hundreds of times greater than the contributions from capacitive phenomena associated with double electrical layer.

At the molecular scale, in the absence of diffusion, the charge of the electrochemical capacitance C_{μ} is directly related to the conductance quantum G, and correlates with the charge transfer rate k of the electrochemical reaction, in such a way that

$$k ( μ ) = ( \frac{2 {e}^{2}}{h} ) {\sum }_{n} {T}_{n} ( μ ) [ \frac{1}{{C}_{μ} ( μ )} ] = G ( μ ) [ \frac{1}{{C}_{e}} + \frac{1}{{C}_{q} ( μ )} ] . \qquad ( 2 )$$

The equation (2) specifically defines the time scale for electron transport/transfer processes that occur in capacitive devices (and defines the processes time for charge and discharge), where h is the Planck constant, e is the charge of the electron, ΣₙTₙ(μ) is the sum of the transmission probabilities through the molecular bridge, and n is the sub-band of the transmission Tₙ(μ) in a given chemical potential, μ. The equation (2) is fundamental to control the loading and unloading time of C_{μ}, and can be controlled by modulating the chemical properties of the interface.

As a result of knowledge and based on research carried out in specialized international and national databases, documents referring to supercapacitors were found, such as the document no. CN1420507A which reveals a supercapacitor with high specific energy for vehicular use, composed of the first electrode made of a material capable of storing energy based on faradaic reactions or pseudo capacitance, and the second electrode made of a material capable of storing energy from the phenomenon of electrical double layers contained in an electrolyte (organic solution).

The document of no. US2012026643A1 reveals a supercapacitor comprising two electrodes, a porous separator disposed between the two electrodes and an ionic liquid electrolyte in physical contact with the two electrodes, in which at least one of the two electrodes comprises a meso-porous structure being formed by a plurality of graphene nano-platelets and multiple pores with a pore size in the range of 2 nm and 25 nm, in which graphene platelets are not spacer-modified or surface-modified platelets. Preferably, the graphene platelets are curved and not flat. The pores are accessible to ionic liquid molecules, allowing the formation of large amounts of charges electrical stored by the principle of electric double layer supercapacitor and that exhibits a high specific capacitance and high energy density.

The document of no. CN106876151A discloses a MnSe/Ni electrode material for a supercapacitor and a method of preparing it. The material is characterized by an active substance of MnSe which is attached to a mesh of Ni substrate in a film structure. The preparation method comprises the steps of preparing a mixture of selenium powders, chloride tetrahydrate manganese, sodium borohydride and an ethanolamine solvent, where all are added to a high-pressure hydrothermal reactor, where the substrate's Ni mesh is also added and the reaction is carried out at a certain temperature. The prepared MnSe/Ni electrode material serves as the electrode modifying material for the supercapacitor; and under a scan speed of 5 mV s⁻¹, the specific electrode capacitance can reach 570 F/g. The prepared MnSe/Ni electrode material has the advantages of high specific capacitance, simple preparation method and low cost, but does not use pseudo-capacitive methods controlled by states coupled to nanostructures, such as modifications with molecules or control of state density.

Thus, it is a fact that the documents mentioned in the paragraphs above do not present any of the characteristics of the object now being perfected, thus ensuring that it meets the legal requirements for patentability.

### OBJECTIVE OF THE INVENTION

An objective of the present invention is to develop cost effective hyper capacitors for energy storage with much more energy density per volume and per mass than existing super-capacitors, preserving all the benefits of energy storage in capacitors devices such as long life based on charge and discharge cycles and fast charging and discharging regimes.

Another objective of the invention may be seen as to improve electrodes for use in hyper capacitors.

A further objective of the present invention may be seen as to provide an alternative to the prior art.

### SUMMARY

An energy storage device, more precisely, a molecular capacitor with very high energy density, denominated as a molecular hyper capacitor, that includes at least one cell having a positive and a negative electrode, as well as an electrolyte between them, where at least one of the electrodes is modified, being formed by a composite, mixing an electric conductive material (plan or porous) with a self-assembled molecular film or coupled in a chemical or physical way, done by redox active molecules.

An energy storage device, that comprehend modified electrodes with films or compounds that are at the molecular or at the mesoscopic scale wherein quantum mechanical characteristics contributes for the pseudo capacitive enhancement to the total equivalent capacitance of the device.

An energy storage device that includes electroactive material that make use of the molecular scale and field effect characteristics.

An energy storage device having pseudocapacitance controlled by active redox molecules immobilized on the surface of the electrode material in which the shielding of the electric field is of a mechanical-quantum nature.

An energy storage device having an interface in mesoscopic scale, with one of its dimensions equal or lower than 10 nm.

An energy storage device having the flatness of the modified conductive electrode interface, controlled by the electrochemical roughness factor (δ) equal or lower than 1.8.

The electrolyte of the energy storage device admits the charge mobility of ionic or polarizable molecular entities and it can be of different composition.

The cell capacitance achievement of the energy storage device is above 500 F g⁻¹ due to the mesoscopic characteristics introduced to the electrode material forming the composite material, producing a storage device with a volumetric energy density above 35 Wh L⁻¹ and a gravimetric energy density above 140 Wh kg⁻¹ when included envelopes and bags to the cells, a container for the cell's stacks, connectors and controllers.

The cell capacitance achievement of the energy storage device is above 1000 F g⁻¹, producing a storage device with a volumetric energy density above 70 Wh L⁻¹, a gravimetric energy density above 275 Wh kg⁻¹ and with a volumetric energy density above 140 Wh L⁻¹ and a gravimetric energy density above 550 Wh kg⁻¹ when included envelopes and bags to the cells, a container for the cell's stacks, connectors and controllers.

The electrochemical active molecules are ferrocene-based compounds, ruthenium-based compounds, cobalt-based compounds, zinc-based compounds, peptides containing metallic complexes, pyridine, pyrenes, hexacianometallate compounds, quinone, organic and inorganic quantum dots, conductive polymers, quinone, redox polymer gels, viologen redox additives, push-pull molecular systems with donor-acceptor characteristics, phthalocyanine compounds, aromatic donor-acceptor molecules, mixed valence compounds or a mixing of them; the selected characteristics of the electrochemical active molecular systems or of the electroactive modifier centers are dependable of the electrode material and must be chosen in the sense to provoke an effective molecular coverage as higher as possible; the greater the number of active molecules immobilized and electronically connected to the current collector and available to contact with the electrolyte, the greater will be the Faradaic contribution (providing pseudocapacitive characteristics) to the final capacitance of the molecular hyper capacitor.

An energy storage device having immobilization of the electrochemical active molecules over the surface of the electrode's conductive material (porous or plan, with controlled rugosity) through a non-electrochemical active supportive monolayer or an “arm” molecule having two ends acting as an electric wire, one end bonded to the electrode's conductive materials and other to the active molecule (redox site); the “arm” or wire connection is selected among peptides, alkanes, natural or synthetic polymers, or any other molecule that equal or lower than 10 nm and that is able to act as a molecular electric bridge between the conductive porous material and the redox-active centers of the hyper capacitor electrochemical system.

The electric conductive material of the electrode is a composite or a carbonaceous material having at least one carbon type of structure such as activated carbon, activated carbon fibers, glassy carbon, graphite paste, graphite intercalation compounds, carbon flakes, nanotubes, graphenes and fullerenes, and at least one active molecule that is immobilized at the conductive material surface.

The electric conductive material of the electrode is a two dimensional (2D) structured material, similar to graphene but not evolving carbon; they can be chosen among transition metal dichalcogenides (TMDCs) such as molybdenum disulfide (MoS₂), tungsten disulfide (WS₂), Molybdenum Diselenide (MoSe₂), sodium bismuthate (NaBiO₃) as well as phosphorene, and at least one active molecule that is immobilized at the conductive material surface.

The electric conductive material of the electrode is a conductive polymer such as polyacetylene, polyparaphenylene, polyparavinylene, polypyrrole, polythiophene, polyalquiltyophene, polyaniline, polyisothionaphthene, polyparaphenylene sulfide and at least one active molecule that is immobilized at the surface; the conductive polymers can also be dopped with carbon structures.

The electric conductive material of the electrode is a metal or a metal oxide composite having at least one of the following element: titanium, indium, aluminum, vanadium, iridium, ruthenium, rhenium, chromium, strontium, cadmium, yttrium, calcium, barium, molybdenum, silicon, boron, manganese, tin, zinc, nickel, iron, silver, lead or cupper and at least one active molecule according claim 10 that is immobilized at the surface; the metal or metal oxide can also be a complement or be complemented by conductive polymers or conductive polymer composites.

The composite material is interconnected with an electric current collector within the electrode; all materials can be disposed together by additive manufacturing system or anchored in a foil, wire, rod or in a sponge by coating, painting or depositing one over the other; the composite as well as the electric conductor material can be built by different layers having different compositions among them.

An energy storage device that three classes of electrolyte can be used: aqueous electrolytes which use water as solvent, organic electrolytes where the solvent is an organic, typically polar solvent and ionic liquids, salts in the liquid form without solvents; the solute is chosen among the following products: methyl ammonium triethyl tetrafluoroborate, tetraethylammonium tetrafluoroborate, tetraethylammonium furoate, ethyl methyl carbonate, ethylene methyl carbonate, ethylene carbonate, diethyl carbonate, dimethyl carbonate, propylene carbonate, salts compromising cations selected from Na⁺, K⁺, Li⁺, Mg²⁺, Ca²⁺, Be²⁺, Sr²⁺ or NH⁴⁺ and ions selected from the group compromising F⁻, I⁻, Br⁻, Cl⁻, NO₃⁻, HSO₄⁻, ClO₄⁻, PF₆⁻, BF₄⁻ and SO₄²⁻ or a mixture thereof and the solvent is chosen among the following products: acetonitrile, dimethyl ketone, propylene carbonate, y-Butyrolactone, water or a mixture thereof.

The concentration of the electrolyte is set according to the temperature limits to maintain the salt solubility in the range above 0.1 M.

### BRIEF DESCRIPTION OF THE DRAWINGS

FIG. 1. (a) shows a simplified design of hyper capacitive electrochemical cells, connected to generate an energy storage device, which can be configured with stacked cells (b1) or with rolled cells (b2). The hyper capacitive cell contains two electrodes (c), an anode and a cathode, mounted on electrical conductors and contacts (f), the electrolyte liquid or gel (d), the electrical insulator (e) that easily permeates the electrolyte or its ions. FIG. 1 (h) shows an example of the hyper capacitive molecular interface on the surface of the conductive porous material of the electrode, where (i) represents a self-assembled electrochemical nanocapacitor, forming mesoscopic interfaces (k) containing, in this case, quantum conductors (“arms”) connected to quantum capacitors and where (I) represents the thickness of the film to be controlled and indicating the need for indirect control of electrochemical roughness, which deals with the ease of interaction between lined sequences of nanocapacitors containing active redox molecules and the electrolyte, and which may be less effective due to surface flaws (j) or impurities in the material used as the electrode (m).

FIG. 2. presents real (a) and imaginary (b) capacitive Bode diagrams of a molecular film of ferrocene thiol molecules containing about 11 self-assembled carbons on top of a flat metallic interface. Non-faradaic contributions (w) are mapped by data acquisition with the electrode positioned outside the redox potential window (or without the addition of the ferrocene thiol molecule). These can later be subtracted from data acquired with the electrode positioned inside (at half-wave potential) of the redox region (intervals indicated by arrows). The resulting “pure” faradaic response is in the curve (y) and shows the smallest contribution from non-faradaic effects to total capacitance (z curve)—the differences are due to the contribution of pseudocapacitive effects. The internal element shows the time scale of the non-faradaic load process of lesser magnitude. The low frequency region indicated in (b) depicts the time scales associated with the total capacitor charge, where the sampling frequency does not influence the resolved capacitance (which is, therefore, a plateau in this region, that is, the time scale of measurement is greater than the time scale of faradaic exchange).

FIG. 3. presents in (a) CV curves of a pure carbon screen-printed electrode. Curve (x) is considered the blank sign, a non-faradaic contribution and, is shown in curve (v), the improvement of redox capacitance activity by adding a fraction of 11 Fc. In (b) Nyquist capacitive diagrams are shown: from the bottom up is the contribution of the effect of adding 11 Fc to the screen-printed electrode of pure carbon. Observe the capacitance that changes from a magnitude of ρF (lower) to a magnitude of mF (upper) when 11 Fc is added.

FIG. 4. show in (a) CV curves of the bare GCE (s), GCE/GO (t) and GCE/RGO (u) in aqueous electrolyte of 0.05 M PBS at a scan rate of 0.1 V s⁻¹. The inner element shows the bare GCE (s) and GCE/GO junction responses (t). In (b) C_{μ} as obtained by electrochemical impedance spectroscopy.

FIG. 5. reveals typical (a) capacitive Nyquist diagrams obtained for GCE (r curve), GO (q curve) and RGO (p curve) in aqueous electrolyte. These diagrams were obtained with a frequency that varies from 1 MHz to 10 MHz, with an amplitude of 10 mV (peak to peak), all acquired with potential at a stationary potential of 0.0 V (in relation to the electrochemical reference electrode Ag|AgCl), where the molecular (quantum) capacitance of graphene is expected to be maximum. The inner element shows the responses from GCE and GO, showing that they are clearly much lower in terms of capacitance, as indicated by the arrows.

### DETAILED DESCRIPTION OF THE INVENTION

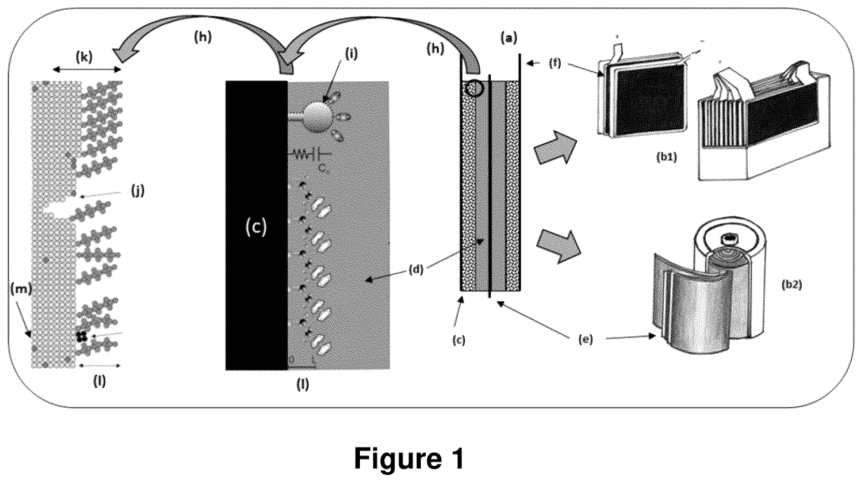

The present invention patent refers to energy storage devices, called molecular hyper capacitors, which includes at least one cell with a positive and a negative electrode, as well as an electrolyte between them, where at least one of the electrodes is formed by a composite material that mixes an electrically conductive material and active molecules (FIG. 1). The composite that mixes the conductive material and the active molecules is desirable to be on the molecular or mesoscopic scale, when the quantum mechanical characteristics contribute as a series of pseudo capacitance, electrostatic or double electrical layer, for the improvement of the total equivalent capacity of the device. By mesoscopic scale it refers to an interface that has a nanoscale equal to or less than 10 nm in one of its dimensions (the thickness in this teaching). The electrolyte also permits the charge mobility of ionic or polarizable molecular entities. The cell capacitance achievement of this technology is above 500 F. g⁻¹ due to the mesoscopic characteristics introduced to the electrode material forming a modified electrode surface, producing a storage device with a volumetric energy density above 35 Wh. L⁻¹ and a gravimetric energy density above 140 Wh. kg⁻¹ when included envelopes and bags to the cells, a container for the cell's stacks, connectors and controllers.

The device is not a battery in the sense that contrary to batteries, where there is the use of redox chemical reactions modifying materials within intercalation processes, but a capacitor containing electroactive material that store energy making use of the molecular scale (without intercalation or diffusion) and with field-effect characteristics that is not associated with a Debye-type of shielding or diffusive ionic processes. The device is also more advanced compared to traditional supercapacitors in the sense that the characteristics of pseudo capacitance are dominated by quantum effects, especially coming from molecules or active redox centers that may be immobilized on the electrode surface or contained in the volume that is defined by the electrode surface area and the scale less than or equal to 10 nm referenced above. Therefore, the shielding of the electric field is of quantum mechanical nature and not classical of the Debye type. The Hyper capacitor is an evolution of the supercapacitors in several ways that mainly includes the minimization of diffusion effects and non-faradaic ones, with predominance of quantum effects, preserving all the benefits of energy storage in capacitor devices, such as the long life based on cycles of loading and unloading and possibilities of fast loading and unloading regimes. This is possible exactly due to the absence of involved redox chemical reactions and which depend on the diffusion processes associated with intercalation.

Hyper capacitors are also an evolution with regard to new forms and techniques on the selection of materials and production processes of the conductive structures involving oxide-reduction reactions (capable of housing redox-type electroactive centers, without the need for ion intercalation for the shielding of the electric field) and as well as on the electronic collectors used in the manufacture of the electrodes of the capacitive cell (or the device), more especially with the insertion of the redox sites through the creation of composite molecular films. There are four most important points to control the production process of the redox composite: first point is to maintain a good coverage of molecular film attached to the surfaces of the material (s) electrode (which can be porous or not, depending on the architecture of the film, but always maintaining a high density of redox states per volume) and with the thickness of this molecular composite film equal to or less than 10 nanometres or, preferably, equal to or less than 5 nm. Several techniques are available nowadays to do this kind of molecular film thickness control such as ellipsometry, atomic force microscopy or x-ray fluorescence. The second point is to know, measure and control the geometrical or physical roughness of the surface of the conductive material to which the film will be attached, being this equal to or less than 40 nm, more preferably equal to or less than 30 nm, obtained through the material selection process and construction processes, as well as quantifying it by AFM measurement techniques, electrochemical techniques such as cyclic voltammograms (where the geometric area is compared to an electroactive area) and/or calculate it using the “quadratic mean” approach. Processes such as electrochemical polishing or even mechanical polishing must be carried out when it is possible to remove nano scratches or nano textures. However, this type of surface characteristics should be avoided preventively, during the manufacture of the conductive material. This second point of control works in fact to facilitate the achievement of the third point, and that is very important, the electrochemical roughness of the surface of the conductive material already modified with a self-assembled molecular film. Electrochemical roughness is associated with the chemical properties of the surface and the expected reactivity at the atomic level. A very useful technique is the use of controlling the electrochemical roughness factor (S) of the surface. It is useful because it is a good estimative of how electrons perceive the electrochemical reactivity and characteristics of an interface when it is immersed into an electrolyte. Factor (δ) values are measured as the ratio between the electro-active area and the geometrical area of an electrode. The flatness of the modified conductive electrode interface controlled by the electrochemical roughness factor (S) must be equal or lower than 1.8 and more preferably equal or lower than 1.4. Finally, the fourth point is the control, or confirmation of the total capacitance itself, which can be measured directly by electrochemical impedance methods or by impedance derived from capacitance spectroscopies.

The design of a hyper capacitor must consider its application cost window, its operational regime and operational expectation of loading and unloading. With these definitions in hand, a hyper capacity cell system can be designed and assembled for the best economical result. A rational selection of materials for the architecture of the cell system requires the development of compatible chemical interactions between the conductive materials and the molecules chosen to compose the thin composite or self-assembled film, as well as the effect of the electrolyte on these chemical interactions in the films. It is shown here that with the correct design of these cells it is possible to produce hypercells with capacitance even above 1000 F·g⁻¹ and preferably above 2000 F·g⁻¹, generating storage devices with volumetric energy density above 70 Wh·L⁻¹ and a gravimetric energy density above 275 Wh·kg⁻¹ and preferably, with a volumetric energy density above 140 Wh·L⁻¹ and a gravimetric energy density above 550 Wh·kg⁻¹, when including envelopes and bags for cells, a container for stacking them, connectors and controllers.

The chosen active molecules must be redox active in essence that can be immobilized at the surface of the electrode material by chemical or physical means, generating a self-assembled thin film or a composite with thickness equal or smaller than 10 nanometer or, more preferably, equal or smaller than 5 nm. The determination of the active molecule(s) together with the conductive porous material must also to consider that the electrochemical roughness stays equal or below 1.8 or, more preferably, equal or below 1.4. The actives molecules can be chosen among ferrocene-based compounds, ruthenium-based compounds, cobalt-based compounds, zinc-based compounds, peptides containing metallic complexes, pyridine, pyrenes, hexacyanometalates compounds, quinone, organic and inorganic quantum dots, conductive polymers, quinone, redox polymer gels, viologen redox additives, push-pull molecular systems with donor-acceptor characteristics, phthalocyanine compounds, aromatic donor-acceptor molecules, mixed valence compounds or a mixing of them. The selected characteristics of the active molecular systems or of the electroactive modifier centers are dependable of the electrode material as said before and must also be chosen in the sense to provoke an effective molecular coverage as higher as possible. The greater the number of active molecules immobilized, electronically connected to the current collector and available for contact with the electrolyte, the greater the contribution of faradaic reactions and the greater the capacitance of the system, leading to pseudo-capacitive characteristics designed with the specific purpose of increasing capacitance end of the molecular hyper capacitor. For the immobilization of electroactive molecules on the surface of the electrode material, aiming at an effective molecular coverage, a non-electroactive support monolayer can be used, that is, an “arm” molecule with two ends, which can act as an electrical wire, in which one end is connected to the conductive material of the electrode and the other to the active molecule (anchorage site redox group). The “arm” or wire connection can be selected from peptides, alkanes, natural or synthetic polymers, or any other molecule equal to or less than 10 nm, and which is capable of acting as a molecular electrical bridge between the conductive material and the active centers redox (or simply electroactive) system electrochemistry of the hyper capacitor. The connection of the molecular wire serves to reduce the deleterious effect of the physical roughness of the conductive surface of the electrode.

Regarding the material for the porous conductive part of the electrochemical hyper capacitance system they can be classified into four main groups: structures of carbon, 2D structured materials, polymers and metals/metal oxides. Into the class of carbon structures, it can be chosen a composite or a carbonaceous material having at least one carbon type of structure such as activated carbon, activated carbon fibers, glassy carbon, graphite paste, graphite intercalation compounds, carbon flakes, nanotubes, graphene and fullerenes.

Other kind of two dimensional (2D) atomic film similar to graphene but not evolving carbon, can also be used and they can be chosen among transition metal dichalcogenides (TMDCs) such as molybdenum disulfide (MoS₂), tungsten disulfide (WS₂), Molybdenum Diselenide (MoSe₂), sodium bismuthate (NaBiO₃) as well as phosphorene. Into the class of polymers, it can be chosen a composite or a conductive polymer such as polyacetylene, polyphenylene, polyparamphenylene, polypyrrole, polythiophene, polyalkylthophene, polyaniline, polyisothionaphthene or polyphenylene sulfide.

Into the metals/metal oxides class it can be chosen a composite, a metal or a metal oxide having at least one of the following elements: titanium, indium, aluminum, vanadium, iridium, ruthenium, rhenium, chromium, strontium, cadmium, yttrium, calcium, barium, molybdenum, silicon, boron, manganese, tin, zinc, nickel, iron, silver, lead or cupper.

The construction of the electrode in general starts by its structural support and this support in general is also used as the current collector that will transport the electrons collected from the electroactive conductive material to the external contacts of the device. The material of the current collectors can be done with the same material of the electroactive conductor or it can be done by different ones chosen among the lists presented before, pure or as composite. The use of the same material avoids one more material interface but it has to take care of other physical demand, as the support of the electrode, and low electrical resistance for high current flow. The electric conductor material as well as the electroactive conductive material as the electrode modifier can be built by different layers having different compositions among them and therefore several small interfaces. All materials can be disposed together by additive manufacturing system or anchored in a foil, wire, rod or in a sponge by coating, painting, spraying or depositing one over the other. The current collector can have some construction patterns to help the electrode physical support as well to facilitate the electron's transfer having less resistance and thermal generation. The surface of the porous conductive material can be treated to expose or create more molecular bonding sites by providing effective molecular film coverage, but also by interfering with the molecular angle (of the arms or the electroactive molecular sites themselves) through the generation of nanoscale undulations and, later, interfering in the electrochemical roughness generated after the redox molecules are interconnected. Acid or basic treatment, polishing of nanoparticles or nano-standard mold in the case of polymers or composites, are additional techniques for the treatment of the interface.

The next step on the hyper-cell production process is the insertion of the molecular electro-active nanoscale film over the electrode conductive material's surface. Various chemical or physical processes are possible to use as an alternative, depending on the class of material chosen. On site molecular synthesis, magnetic deposition, electro deposition, doping, several kinds of painting (silk-screen, spray, inkjet, spin and so on) and several kinds of ALD—Atomic Layer Deposition (thermal, photo-assisted, plasma and elimination reactions) are the actual art techniques.

Having the electrodes done they are assembled in pairs, separated by the isolator material in a cell configuration, then connected together several cells in a single container or individually in a bag, envelope or in similar container. More flexible material can produce a hyper capacitor assembled as circular enrolled electrodes or superposed intercalated rectangular electrodes in a stack configuration. The cells can be connected with others in a series or parallel mode to adjust the final device characteristics in terms of operational voltage and capacitance at the device's contact. Before closing the bags or the containers the electrolyte is introduced to finalize the electrochemical cell system. Three class of electrolyte can be used, aqueous electrolytes which use water as solvent, organic electrolytes where the solvent is an organic, typically polar solvent and ionic liquids and salts in the liquid form without solvents. Ionic liquids are perfect but they are extremely expensive. Aqueous electrolytes are safer and use low-cost materials but they have a limited voltage range because of the small electrochemical stability window of water (1.23 V), therefore provoking lower energy density devices. Organic electrolytes are the most common electrolytes at the market because it allows for charge voltages up to 2.5 to 2.8 V. A Hybrid electrolyte compromises a mixture of water, one or more organic solvents and one or two different kinds of salts. The electrolyte can be prepared as a solution or as a gel and the jellified version may avoid the separator between the electrodes. The operational temperature of the device must be considered to select the best cost benefit system for the hyper capacitor to avoid frozen or higher evaporation. The solute is chosen among the following products: methyl ammonium triethyl tetrafluoroborate, tetraethylammonium tetrafluoroborate, tetraethylammonium furoate, ethyl methyl carbonate, ethylene methyl carbonate, ethylene carbonate, diethyl carbonate, dimethyl carbonate, propylene carbonate, salts compromising cations selected from Na⁺, K⁺, Li⁺, Mg²⁺, Ca²⁺, Be²⁺, Sr²⁺ or NH⁴⁺ and ions selected from the group compromising F⁻¹, I⁻¹, Br⁻¹, Cl⁻¹, NO₃⁻¹, HSO₄⁻¹, CO₄⁻¹, PF₆⁻¹, BF₄⁻¹ and SO₄²⁻ or a mixture thereof and the solvent is chosen among the following products: acetonitrile, dimethyl ketone, propylene carbonate, y-Butyrolactone, water or a mixture thereof. The concentration of the electrolyte is set according the temperature limits to maintain the salt solubility in the range above 0.1 M.

### Exemplification—Case 1

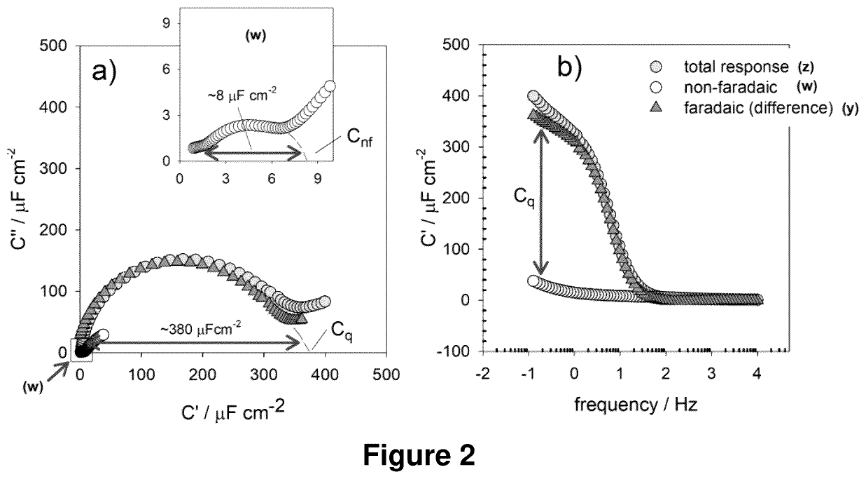

FIG. 2 shows the response of a highly flat modified metallic (aluminium foil, for instance) electrode interface (flatness controlled by the electrochemical roughness factor; lower than 1.4; with commercial alkyl thiol molecules containing ferrocene (11 Fc) where it is shown that, at the faradaic windows, specifically at the half-wave or Fermi level or the corresponding potential energy of the electrode, the pseudo capacitance of the interface maximizes to 380 μF cm⁻² (about 2000 F g⁻¹) and is only 8 μF cm⁻² (about 300 F g⁻¹) when there is no contribution of the ferrocene states of the interface to the capacitance, clearly indicating that the participation of the redox states (in a diffusion-less situation) to the capacitance has a huge influence in the charge response due to the presence of the redox-active molecules. The electrolyte used was tetrabutylammonium hexafluorophosphate with dielectric constant of about 10. If a solvent of higher dielectric constant than dimethylformamide, such as acetonitrile (dielectric constant of about 40) is used, the capacitance decreases to about 190 μF cm⁻² (about 980 F g⁻¹) and it decreases to about 120 μF cm⁻² (about 653 F g⁻¹) in aqueous solution (dielectric constant of about 80).

Regardless of the solvent, the contribution of the interaction of redox groups with the film, in this type of interface, provides an increase of more than 100 times the equivalent and final capacitance of the interface C_{μ}. It is also important to note that the capacitive analyses resolved in frequency reproduce what is expected in equation (1). The increase in capacitance is due to the charge of the HOMO-LUMO states of the molecular film, which is a contribution promoted by C_{q}; this is due to the series combination of Cₑ and C_{q} (in equation 1) for the equivalent capacitance C_{μ}, where Cₑ>>C_{q}, according to the shielding mechanism of the electric field that operates on this type of interface. In this situation, clearly C_{μ}˜C_{q}, and the redox dynamics k=G/C_{q} (obtained from equation 2) is dominated by quantum effects.

The charge and discharge (electron exchange) of this equivalent capacitor are controlled, in the present case, by Equation (2), where it can be noted that G=1/R_{ct}, and R_{ct} is the electron transfer resistance, being, as already said, k=G/C_{q}.

There is a size effect associated with the coupling of the redox centres to the electrode. The higher the distance of the redox centres to the electrode the lower the capacitance. The lower the distance the higher the capacitance. This is a reflection of the effect of a higher density of redox states per volume, which promotes a drastic increase in capacitance.

Using these electrodes to assemble the energy storage devices (hyper capacitor) in a stack configuration containing 100 cells of about 6 per 10 cm of active area per electrode, an isolating and porous paper as separators (cellulose semi crystalline), an aluminium container with 2 μm wall's thickness and aluminium contact screws of 11 mm, provide volumetric energy density of about 140 Wh·L⁻¹ and gravimetric energy density of 550 Wh·kg⁻¹ for tetrabutylammonium hexafluorophosphate electrolyte, volumetric energy density of about 68.5 Wh·L⁻¹ and gravimetric energy density of 268.5 Wh·kg⁻¹ for acetonitrile and volumetric energy density of about 45.5 Wh·L⁻¹ and gravimetric energy density of 178 Wh·kg⁻¹ for aqueous solution.

### Exemplification—Case 2

The interface utilised in this case comprises a simple electrochemically active peptide (Fc-Glu-Ala-Ala-Cys) sequence obtained through a low-cost solid phase synthesis (SPPS) and which was optimized to operate in an aqueous solvent containing 20% of acetonitrile. Synthesis commenced from the C-terminal cysteine utilised in anchoring the molecule to a metallic electrode surface (aluminium foil, for instance). It is important to note that, after cleavage of the ‘Rink Amide’ resin peptide, the C-terminal carboxy group remained in the medium to avoid negative charges near the surface anchorage site, charges that could prevent lateral packaging. Two alanine residues were introduced to promote film crystallinity, then a N-terminal glutamic acid was integrated. The structure and purity of the peptide was confirmed by mass spectrometry and HPLC (purity of >98%). The infrared spectrum displays a signal near 1654 cm⁻¹, characteristic of amide I band of random coils structure in good agreement with the circular dichroism studies (data not shown).

Importantly here is that, in this case, a capacitance of about 260 μF cm⁻² was achieved corresponding to about 1415 F g⁻¹. Details of the capacitive properties of the interface is shown in the Table below:

TABLE 1
Redox-active peptide self-assembled on a metallic interface-
calculation of the capacitance per gram of material.

| | Molecular | Molecular | |
|---|---|---|---|
| C_{μ} | Coverage | Coverage^{a} | C_{μ} |
| (μF cm⁻²) | (mole cm⁻²) | (g cm⁻²) | (F g⁻¹) |
| 259.6 ± 23.7 | (2.75 ± 0.25) 10⁻¹⁰ | (1.83 ± 0.17) 10⁻⁷ | 1415.41^{b} |

^{a}Gram per cm² was calculated by using the molecular mass of the peptide (665 g mole⁻¹);
^{b}Standard deviation were calculated by 10 independent values. However, the standard deviation of C_{μ} in F g⁻¹ was almost null. Average area 0.048 cm².

Using these electrodes to assemble the hyper capacitor in the same stack configuration than the case 1 example provides volumetric energy density of about 99 Wh·L⁻¹ and gravimetric energy density of 390 Wh·kg⁻¹

### Exemplification—Case 3

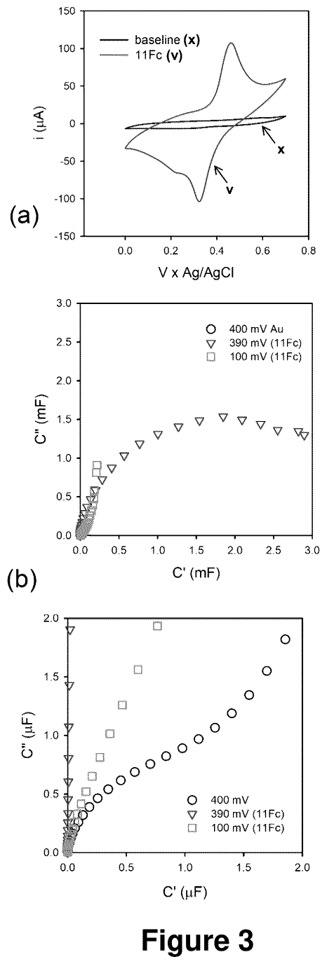

In this section it is shown the effect of adding 11 Fc of the case 1 into a porous carbon screen-printed electrode. Screen-printed electrode has around 1 μm in thickness. The increase in the redox-activity of the electrode is noted in FIG. 3(a) by comparing the (x) and (v) curves. The capacitance is confirmed to be hugely increased from μF [bottom diagrams in (b)] to mF, i.e. an increase of about 1,000 times in the capacitance of the interface.

### Exemplification—Case 4

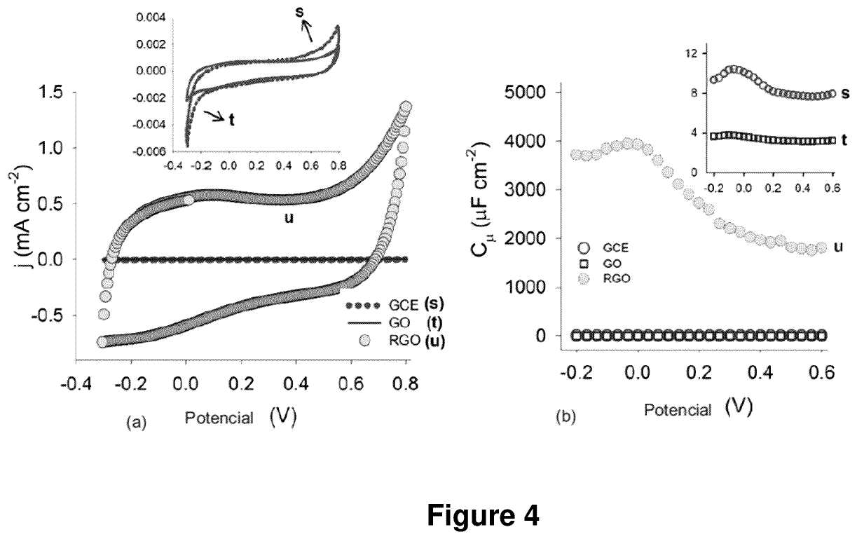

In this section it is shown the effect on C_{μ} owing to modification and to the doping of sheets of graphene oxide (GO) that can be further integrated, in a multilayer format, to a conductive carbon electrode such as glassy carbon. This process greatly improves C_{μ} of the interface due to the creation of DOS (density of states) in the GO sheets that increases the contribution of C_{q} over Cₑ states in the volume of the electroactive material of the capacitor. By reducing GO directly on the surface of a glass carbon electrode GCE we obtained a GO-modified GC electrode that exhibits an enhanced capacitive performance, as shown in FIG. 4.

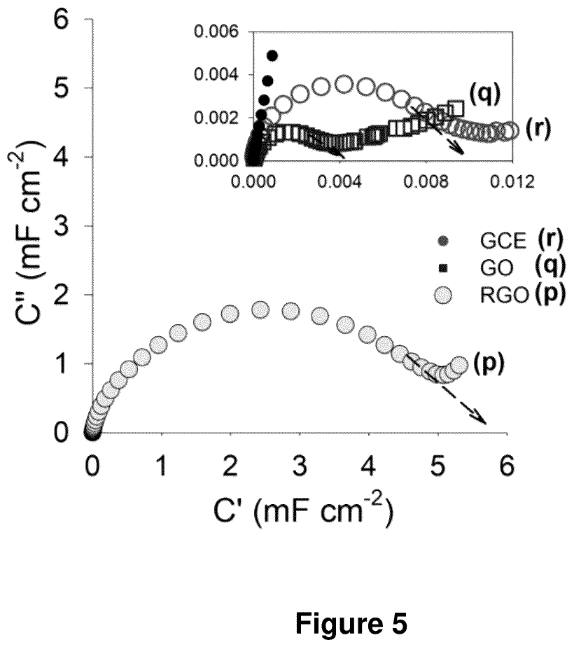

FIG. 4(a) shows cyclic voltammograms obtained at 0.100 V s⁻¹ for GCE (s), GCE/GO (tt), and GCE/RGO (u) in aqueous electrode. Compared to GCE/GO, the current-potential profiles obtained at GCE/RGO shows higher capacitance currents, which occurs because the GO contains a large amount of oxygen. The long-range sp² structure is typically absent and the material is a mixture of sp³ and sp² hybridized carbons with very low conductivity, while in electrochemically reduced graphene, the oxygen-containing groups are partially removed and the sp² order in graphene structure is restored. Therefore, the RGO efficient electron transport properties combined with its charge capability as predicted by Equation (2) and experimentally confirmed by using electrochemical impedance spectroscopy (EIS) measurement as shown in FIGS. 4(b) and 5 allows us to demonstrate a significant improvement of C_{μ} by a margin of 5,000 times.

It is certain that when the present invention is put into practice, modifications may be made with regard to certain details, without this implying departing from the fundamental principles that are clearly substantiated in the claim framework, thus making it understood that the terminology employed does not had the purpose of limitation.

1. An energy storage device, characterized as a molecular capacitor with very high energy density, denominated as a molecular hyper capacitor, that includes at least one cell having a positive and a negative electrode, as well as an electrolyte between them, where at least one of the electrodes is modified, being formed by a composite, mixing an electric conductive material (plan or porous) with a self-assembled molecular film or coupled in a chemical or physical way, done by redox active molecules.

2. An energy storage device, according to claim 1, characterized by the fact that the modified electrodes are at the molecular or at the mesoscopic scale wherein quantum mechanical characteristics contributes for the pseudo capacitive enhancement to the total equivalent capacitance of the device.

3. An energy storage device, according to claim 1, characterized by the fact that the hyper molecular capacitor includes electroactive material that make use of the molecular scale and field effect characteristics.

4. An energy storage device, according to claim 1, characterized by having pseudocapacitance controlled by active redox molecules immobilized on the surface of the electrode material in which the shielding of the electric field is of a mechanical-quantum nature.

5. An energy storage device, according to claim 4, characterized by having an interface in mesoscopic scale, with one of its dimensions equal or lower than 10 nm.

6. An energy storage device, according to claim 5, characterized by having the flatness of the modified conductive electrode interface, controlled by the electrochemical roughness factor (δ) equal or lower than 1.8.

7. An energy storage device, according to claim 6, characterized by the fact that the electrolyte admits the charge mobility of ionic or polarizable molecular entities and it can be of different composition.

8. An energy storage device, according to claim 1, characterized by being configured to have the cell capacitance achievement of this technology above 500 F g⁻¹ due to the mesoscopic characteristics introduced to the electrode material forming the composite material, producing a storage device with a volumetric energy density above 35 Wh L⁻¹ and a gravimetric energy density above 140 Wh kg-1 when included envelopes and bags to the cells, a container for the cell's stacks, connectors and controllers.

9. An energy storage device, according to the claim 1, characterized by the fact that it is configured to have the cell capacitance achievement above 1000 F g⁻¹, producing a storage device with a volumetric energy density above 70 Wh L⁻¹, a gravimetric energy density above 275 Wh kg⁻¹ and with a volumetric energy density above 140 Wh L⁻¹ and a gravimetric energy density above 550 Wh kg⁻¹ when included envelopes and bags to the cells, a container for the cell's stacks, connectors and controllers.

10. An energy storage device, according to claim 1 characterized by the fact that it is configured to have electrochemical active molecules such as ferrocene-based compounds, ruthenium-based compounds, cobalt-based compounds, zinc-based compounds, peptides containing metallic complexes, pyridine, pyrenes, hexacianometallate compounds, quinone, organic and inorganic quantum dots, conductive polymers, quinone, redox polymer gels, viologen redox additives, push-pull molecular systems with donor-acceptor characteristics, phthalocyanine compounds, aromatic donor-acceptor molecules, mixed valence compounds or a mixing of them; the selected characteristics of the electrochemical active molecular systems or of the electroactive modifier centers are dependable of the electrode material and must be chosen in the sense to provoke an effective molecular coverage as higher as possible; the greater the number of active molecules immobilized and electronically connected to the current collector and available to contact with the electrolyte, the greater will be the Faradaic contribution (providing pseudocapacitive characteristics) to the final capacitance of the molecular hyper capacitor.

11. An energy storage device, according to claim 10, characterized by the fact that it is configured to have immobilization of the electrochemical active molecules over the surface of the electrode's conductive material (porous or plan, with controlled rugosity) through a non-electrochemical active supportive monolayer or an “arm” molecule having two ends acting as an electric wire, one end bonded to the electrode's conductive materials and other to the active molecule (redox site); the “arm” or wire connection is selected among peptides, alkanes, natural or synthetic polymers, or any other molecule that equal or lower than 10 nm and that is able to act as a molecular electric bridge between the conductive porous material and the redox-active centers of the hyper capacitor electrochemical system.

12. An energy storage device, according to claim 1Q, characterized by the fact that it is configured to have an electric conductive material of the electrode, which is a composite or a carbonaceous material having at least one carbon type of structure such as activated carbon, activated carbon fibers, glassy carbon, graphite paste, graphite intercalation compounds, carbon flakes, nanotubes, graphenes and fullerenes, wherein at least one active molecule is immobilized at the conductive material surface.

13. An energy storage device, according to claim 10, characterized by the fact that it is configured to have an electric conductive material of the electrode, which is a two dimensional (2D) structured material, similar to graphene but not evolving carbon; they can be chosen among transition metal dichalcogenides (TMDCs) such as molybdenum disulfide (MoS₂), tungsten disulfide (WS₂), Molybdenum Diselenide (MoSe₂), sodium bismuthate (NaBiO₃) as well as phosphorene, wherein at least one active molecule is immobilized at the conductive material surface.

14. An energy storage device, according to claim 10, characterized by the fact that it is configured to have an electric conductive material of the electrode, which is a conductive polymer such as polyacetylene, polyparaphenylene, polyparavinylene, polypyrrole, polythiophene, polyalquiltyophene, polyaniline, polyisothionaphthene, polyparaphenylene sulfide, wherein at least one active molecule.

15. An energy storage device, according to claim 10, characterized by the fact that it is configured to have an electric conductive material of the electrode, which is a metal or a metal oxide composite having at least one of the following element: titanium, indium, aluminum, vanadium, iridium, ruthenium, rhenium, chromium, strontium, cadmium, yttrium, calcium, barium, molybdenum, silicon, boron, manganese, tin, zinc, nickel, iron, silver, lead or copper, wherein at least one active molecule is immobilized at the surface.

16. An energy storage device, according to claim 15, characterized by the fact that it is configured to have a composite material which is interconnected with an electric current collector within the electrode; all materials can be disposed together by additive manufacturing system or anchored in a foil, wire, rod or in a sponge by coating, painting or depositing one over the other; the composite as well as the electric conductor material can be built by different layers having different compositions among them.

17. An energy storage device, according to claim 1, characterized by the fact that it is configured to have three classes of electrolyte that can be used: aqueous electrolytes which use water as solvent, organic electrolytes where the solvent is an organic, typically polar solvent and ionic liquids, salts in the liquid form without solvents; the solute is chosen among the following products: methyl ammonium triethyl tetrafluoroborate, tetraethylammonium tetrafluoroborate, tetraethylammonium furoate, ethyl methyl carbonate, ethylene methyl carbonate, ethylene carbonate, diethyl carbonate, dimethyl carbonate, propylene carbonate, salts compromising cations selected from Na⁺, K⁺, Li⁺, Mg²⁺, Ca²⁺, Be²⁺, Sr²⁺ or NH⁴⁺ and ions selected from the group compromising F⁻, I⁻, Br⁻, Cl⁻, NO₃⁻, HSO₄⁻, ClO₄⁻, PF₆⁻, BF₄⁻ and SO₄²⁻ or a mixture thereof and the solvent is chosen among the following products: acetonitrile, dimethyl ketone, propylene carbonate, y-Butyrolactone, water or a mixture thereof.

18. An energy storage device, according to claim 17, characterized by the fact that it is configured to have the concentration of the electrolyte set according to the temperature limits to maintain the salt solubility in the range above 0.1 M.
